(19) United States
(12) Patent Application Publication
(10) Pub. No.: US 2012/0210269 A1
(43) Pub. Date: Aug. 16, 2012

(54) BOOKMARK FUNCTIONALITY FOR READER DEVICES AND APPLICATIONS

(75) Inventor: Andrew Yonemoto, San Jose, CA (US)

(73) Assignee: Sony Corporation, Tokyo (JP)

(21) Appl. No.: 13/028,747

(22) Filed: Feb. 16, 2011

(51) Int. Cl. G06F 3/048

(52) U.S. Cl. 715/776

(57) ABSTRACT

Methods and apparatus are provided for presenting a reader application. In one embodiment a method includes displaying a user interface for a reader application, the user interface including a graphical representation identifying a digital book, and detecting a selection of the user interface associated with the graphical representation identifying the digital book. The method may further include detecting a bookmark file associated with the digital book, the bookmark file stored by the device, and presenting data associated with the bookmark file by the device, wherein the data is presented in association with presentation of the digital book. The method may allow for presenting one or more of a greeting message and digital engraving as an overlay to the digital book.

### FIELD

The present disclosure relates generally to electronic readers and reader applications, and more particularly to methods and apparatus for presenting an electronic reader application.

### BACKGROUND

Typical electronic reading devices (e.g., eReaders, eBook readers, etc.) allow for users to purchase, download and browse digital books (e.g., eBooks). Currently, most digital reading content is associated with the same format. As such, the same digital book may be purchased from one or more outlets. As a result, manufacturers of reader devices market functional or aesthetic features of reader devices and applications to spur consumer interest. Similarly, consumers desire functionality of reader devices and applications to provide fun or convenient features.

One conventional feature of reading devices is a digital equivalent of a bookmark, wherein a physical bookmark may be mimicked by the reader device. In some devices, this may be a standard feature associated with providing a display of an image mimicking a bookmark. However, this conventional feature is typically limited to presenting a graphical display. Conventional digital bookmarks are limited in use, and typically do not allow for content to be provided to a user of the reader device. Further, conventional digital bookmarks are not transferable and cannot be personalized. There is a desire to provide features for digital bookmarks in additional to the functions of conventional bookmarks.

One limitation of the reader devices may be the read-only format of digital books. For example, conventional reader devices and applications do not allow for digital books to be personalized. Traditional methods of inscribing a message in a book, especially when the book is a gift, is not possible with conventional readers. Further, the conventional methods do not address identifying digital books that may be gifts, or storage of messages associated with books. As such, there is a desire for functionality by reader devices and applications that overcome one or more of the aforementioned drawbacks and provide useful technological solutions and functionality that may increase consumer interest.

### BRIEF SUMMARY OF THE EMBODIMENTS

Disclosed and claimed herein are methods and apparatus for presenting a reader application. In one embodiment, a method includes displaying, by a device, a user interface for a reader application, the user interface including a graphical representation identifying a digital book, and detecting a selection, by the device, of the user interface associated with the graphical representation identifying the digital book. The method further includes detecting a bookmark file associated with the digital book, the bookmark file stored by the device, and presenting data associated with the bookmark file by the device, wherein the data is presented in association with presentation of the digital book.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a device configured to provide a reader application according to one or more embodiments;

FIG. 2 depicts a process for presenting a reader application according to one or more embodiments;

FIG. 3 depicts a simplified block diagram of a device according to one embodiment;

FIG. 4 depicts a graphical representation of a user interface of a reader application according to one or more embodiments;

FIG. 5 depicts a graphical representation of a message according to one or more embodiments;

FIG. 6 depicts a graphical representation of data associated with a bookmark file according to one or more additional embodiments;

FIG. 7 depicts a simplified system diagram which may be employed for creating and transferring bookmark files and data for reader applications according to one or more embodiments; and

FIG. 8 depicts a process for operation of a reader application according to one embodiment.

### DETAILED DESCRIPTION OF THE EXEMPLARY EMBODIMENTS

### Overview and Terminology

One aspect of the of the disclosure relates to reader devices and reader applications. A reader application may relate to an executable application configured for presentation of text for one or more digital books on a display of a device. In one embodiment, a bookmark file may be provided for one or more of a reader device and reader application. A bookmark file as used herein may provide one or more functions. Unlike conventional digital bookmarks that may be employed by a reader device, the bookmark file as described herein may be configured to store one or more different types of data including image, audio, video, and animation content. Similarly, the bookmark file may be personalized such that users can create an appearance and provide particular functionality for a digital bookmark. In certain embodiments, the bookmark file may contain interactive content and/or allow for interaction with network accessible content. Presentation of data for the bookmark file may be associated with presentation of an reader application for viewing, purchasing, and downloading digital books and data in general. In certain embodiments, a reader device and/or application may be configured to store or operate with multiple bookmark files. A bookmark file may be associated or paired to one or more digital books.

According to another embodiment, a bookmark file may relate to a container or storage format for housing text, graphics (images), video, animation, and/or interactive files. Interactive files stored by the bookmark file may include a static presentation element configured to initiate a function based on a user selection. For example, user selection of the bookmark file can initiate opening a network browser application, presenting an animation, output of audio data, message display, etc.

A bookmark file as described herein may be employed by a reader device or application to allow for the digital equivalent of a bookmark, to provide data for a message such as a greeting card or inscription to a digital book, to identify digital books that are gifts, providing data for collectable and/or novelty elements, and used as a gift certificate. As will be described herein, it should also be appreciated that a bookmark file may allow for additional uses.

In one embodiment, a method is provided for presenting a reader application. Presentation of the reader application may be based on selection of a digital book and may include presenting data associated with a bookmark file. By way of example, user selection of a digital book that that is received as a gift may result in display of a message, such as an inscription or digital greeting card when selected by a user. According to another embodiment, presentation of the reader application may include detecting a selection of a graphical representation associated with a bookmark file, and presenting data associated with the bookmark file by the device. The methods may include presenting data associated with a bookmark file in addition to data of a digital book and/or include presenting data of the bookmark file instead of the digital book. The presentation of data associated with a bookmark file may advantageously introduce fun and convenience to users of reading devices and applications. In contrast to conventional methods for displaying a digital bookmark, the methods and devices described herein allow for improved access and viewing of information associated with a bookmark file.

In another embodiment, a device is provided which may be configured to store one or more bookmark files and present a reader application. The device may relate to a reader or device in general configured to provide a reader application.

According to another aspect, data may be communicated relative to reader devices and applications via bookmark files. For example, bookmark file may be configured to be transmitted and include data to enable a reader device or application to download a digital book. Methods and systems are described herein for managing, transferring, adding, and removing data for a bookmark file.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or alike electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

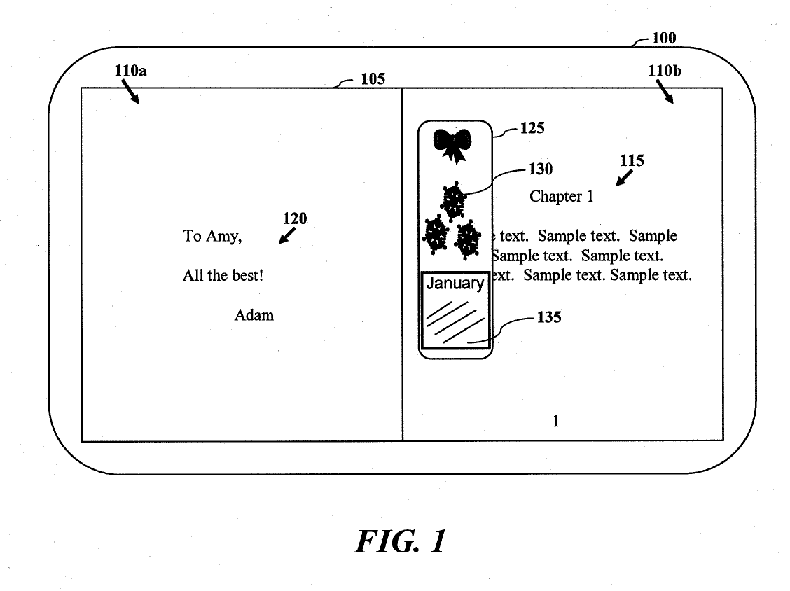

Referring now to the figures, FIG. 1 depicts a graphical representation of a device configured to provide a reader application according to one or more embodiments. Device 100 may relate to one or more of a reader (e.g., eReader, digital, etc.), a computing device, a personal communication device, a tablet computer, and device in general configured to run a reader application. Device 100 includes display 105 which may be configured to display a user interface for a reader application. Display 105 may be configured to display one or more of a single page format and multiple page format. The display configuration of a user interface and/or reader application may be based on the orientation of device 100. Display 105 may be configured to display a user interface for an application in one or more of a landscape and portrait format.

As depicted in FIG. 1, display 105 depicts an exemplary display configuration for a reader application according to one or more embodiments. In particular, device 100 is depicted in a landscape orientation in FIG. 1. Display 105 includes a dual page display including pages 110a and 110b. Data and graphical elements presented by display 105 for pages 110a and 110b may be based on data of a digital book. As depicted in FIG. 1, text of a digital book is identified by 115.

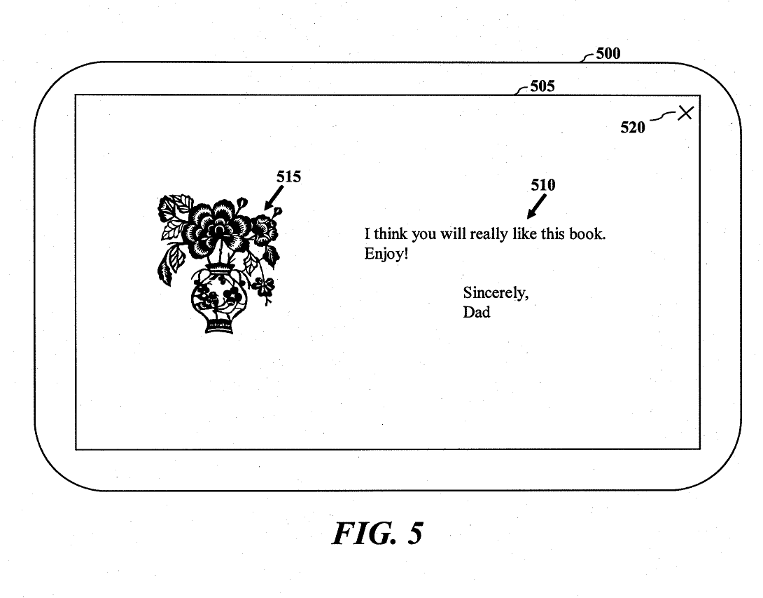

Display 105 may present data associated with a bookmark file. According to one embodiment of the invention, a bookmark file may be employed to allow for a digital engraving to be associated with a digital book. Digital engraving may relate to a message, or digital inscription, that may be associated with display of a digital book. By way of example, a bookmark file may be created by a user and transmitted with a message for a digital engraving. In certain embodiments, the bookmark file may include information, such as a gift certificate, for purchase of a digital book. Upon receipt of the bookmark file by an intended recipient, the bookmark file may be opened by a device, such as a reader device. When a digital book is pre-purchased, a user selection associated with a bookmark file may initiate download of the digital book. The digital engraving may be displayed when a user selects a digital book for reading. Page 110a includes an exemplary graphical representation of the digital graving identified as 120. Display of the digital engraving may relate to overlaid text or image data of the engraving on a page of the digital book. In certain embodiments, the digital engraving may appear as a page of the display, such as the jacket, when the device is configured for multiple page display. When the device is configured for a single page display, the digital engraving may be displayed for a time period prior to display of the digital book. A greeting message may similarly be displayed as will be discussed below in more detail with respect to FIG. 5.

A bookmark file may be associated or paired with a particular digital book. Further, a bookmark file may be employed to store one or more of audio, and visual data that may be presented by device 100. For example, a bookmark file may be employed to display a digital bookmark. As depicted in FIG. 1, a graphical representation of a bookmark is depicted as 125. Bookmark 125 may be displayed based on data stored by device 100 for a bookmark file. In FIG. 1, bookmark 125 is depicted to include image data 130 and a graphical representation of a calendar 135. Image data 130 may be personalized by a user. In some embodiments, image data 130 may relate to user selected image data. Image data 130 may similarly relate to image data to create a novelty digital bookmark, wherein the image data is associated with artwork for a particular title, such as a bestseller. In other embodiments, image data 130 may be personalized based on personal photos/images of a user. Personalization of image data 130 may introduce a desirable feature for potential customers. Calendar 130 may be presented as an animation or image. Image data 130 and calendar 135 may be stored by a bookmark file. Although personalization of the digital bookmark is described above with reference to image data, it should be appreciated that a reader application may output audio data, such as recorded voice, for presentation of bookmark data. Further, the bookmark file may be employed to storing data associated with identifying a page, or position, within a digital book.

As shown in FIG. 1, bookmark 125 is depicted on page 110b. In certain embodiments, device 100 may display bookmark 125 upon selection of a digital book, and for a period of time following initial display on page 110b. In certain embodiments, the device may detect a user input related to a desired position for marking the digital book. As such, device 100 may display bookmark 125. It should also be appreciated that device 100 may allow for a user to drag, or position, bookmark 125 to one or more pages of the digital book.

According to another embodiment, video and/or animation data associated with a bookmark file may be presented when a user selects a digital book for reading and/or during presentation of digital book 115. The presentation of video and/or animation data may be in addition to text and image data stored by the bookmark file. In one exemplary embodiment, while reading digital book 115, the reader application may present a portion (e.g., a tip, section, miniaturized version, etc.) of digital bookmark 125 at a top edge of display 105. Selection of a displayed portion of digital bookmark 125 may initiate display of a page marked by the digital bookmark. By way of further example, digital bookmark 125 is displayed on page 110b identified as page one in FIG. 1. By selecting the above identified display of a portion of the digital bookmark while the reader application is presenting another page, such as page fifty, the reader application will then display page one associated with the position of digital bookmark 125. Display of page 110b may include display of a digital bookmark including an animation or video.

Although FIG. 1 has been described above with reference to display of a two page configuration, it should also be appreciated that the devices and methods described herein may similarly apply the features to single page and/or portrait display configurations.

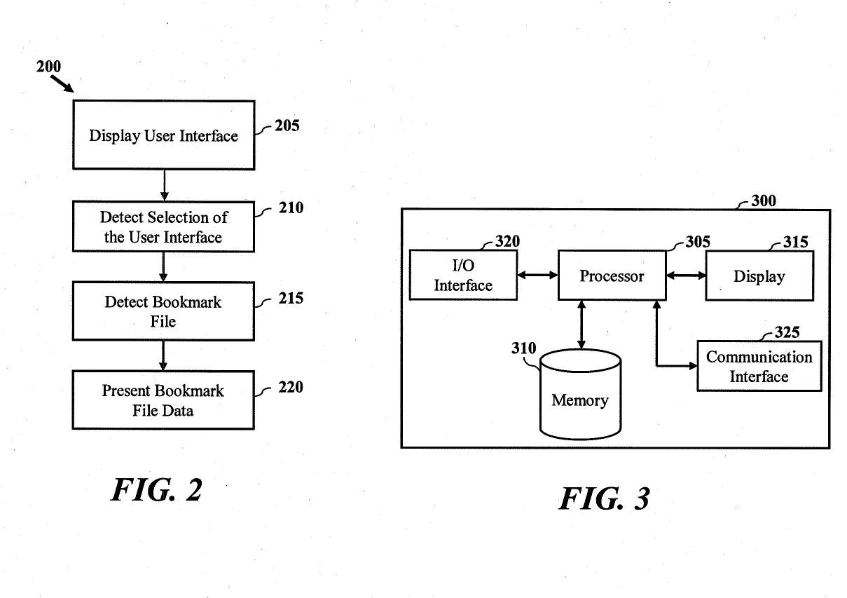

Referring now to FIG. 2, a process is depicted for presenting a reader application according to one or more embodiments. A reader application may relate to an executable application configured for presentation of text for one or more digital books on a display of the device. Process 200 may be employed to present data associated with a bookmark file according to one embodiment. Process 200 may be employed by the device of FIG. 1, eReader devices and devices configured to provide reader applications, such as computing devices, personal communication devices, media players, gaming systems, etc.

Process 200 may be initiated by displaying a user interface at block 205. The user interface may include graphical representation elements to identify one or more digital books. A graphical representation may relate to a list element and/or graphical icon identifying a digital book, such as a title or image identifying the digital book. The graphical representation of a digital book may include a graphical element to identify the digital book as a gift. At block 210, the device may detect a selection of the user interface associated with the graphical representation of a digital book. Based on a selection of the user interface at block 210, the device may determine if a bookmark file is associated with the digital book.

Process 200 may proceed to detect a bookmark file stored by a device at block 215. A bookmark file may be configured to store one or more of audio data, video data, image data and an identification of at least one digital book. Similarly, the bookmark file may be configured to provide data associated with one or more of a digital gift card and data for purchase of a digital book. The bookmark file may additionally be configured to store data to link the bookmark file with at least one digital book.

Based on a detected bookmark file, the device may present data at block 220. By way of example, when the selection of the digital book relates to the first time a digital book is accessed by a user, the device may display, message data, such as a digital greeting card or digital engraving associated with the bookmark file. Display of message data of the bookmark file relating to a greeting card is discussed in more detail below with respect to FIG. 8. According to another embodiment, presenting data of the bookmark file may relate to output of one or more of audio, image and video data on a device display. One advantage of presenting the information based on the bookmark file may be to allow for users to associate a purchase of a digital book with a message intended for a recipient of the digital book.

Although the description of process 200 has been described with reference to digital books, it should also be appreciated that the methods and devices described herein are not limited to digital books or reader applications. For example, the devices and methods described herein may be employed for viewing data associated with calendaring or read-only files.

Referring now to FIG. 3, a simplified block diagram is depicted of a device according to one embodiment. Device 300 may relate to a reader device configured to display graphical representations of text associated with one or more of digital books, eBooks, electronic publications, and digital text in general. In one embodiment, device 300 relates to the device of FIG. 1. As depicted in FIG. 3, device 300 includes processor 305, memory 310, display 315, input/output (I/O) interface 320, and communication interface 325. Processor 305 may be configured to control operation of device 300 based on one or more computer executable instructions stored in memory 310. In one embodiment, processor 305 may be configured to execute a reader application. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more digital books and bookmark files.

Display 315 may be employed to display text, image and/or video data, and display one or more applications executed by processor 305. In certain embodiments, display 315 may relate to a touch screen display. I/O interface 320 may be employed to control operation of device 300 including controlling playback of an eBook and/or digital publication. I/O interface 320 may include one or more buttons for user input, such as a such as a numerical keypad, volume control, menu controls, pointing device, track ball, mode selection buttons, and playback functionality (e.g., play, stop, pause, forward, reverse, slow motion, etc). Buttons of I/O interface 320 may include hard and soft buttons, wherein functionality of the soft buttons may be based on one or more applications running on device 300.

Communication interface 325 may be configured to receive and/or transmit data including bookmark files, text files, digital books, and information associated with one or more devices via wired or wireless communication (e.g., Bluetooth™, infrared, etc.). Communication interface 325 may be configured to allow for one or more devices to communicate with device 300 via wired or wireless communication. Communication interface 325 may include one or more ports for receiving data, including ports for removable memory. Communication interface 325 may be configured to allow for network based communications including but not limited to LAN, WAN, Wi-Fi, etc. In one embodiment, communication interface 325 may be configured to access a digital book via a network server.

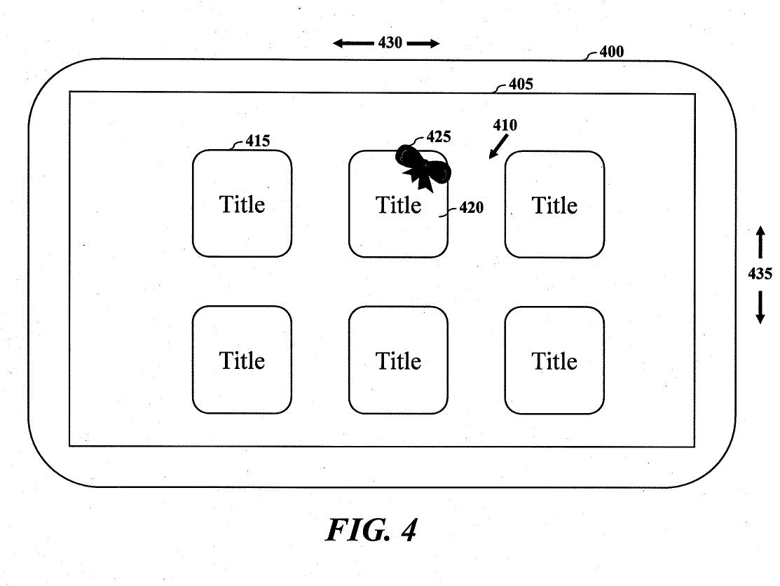

Referring now FIG. 4, a graphical representation is depicted of a user interface of a reader application. Device 400 (e.g., device 300) includes display 405 to present the user interface of the reader application. Display 405 is depicted in a landscape orientation. According to one embodiment, the user interface of the reader application may allow a user to view one or more graphical elements of digital books shown as 410. Graphical elements 410 are depicted as tiles or icons, wherein each tile may identify a digital book that may be displayed by the reader application. In one embodiment, graphical elements 410 may relate to digital books stored by the device. Display of digital books for purchase from a server or digital book site may similarly be displayed. According to another embodiment, digital books displayed by the reader application may relate to a listing of digital book titles.

Although, a bookmark file may be employed to provide a digital bookmark (e.g., digital bookmark 125) for one or more digital books stored by a device, the reader application may be configured to identify one or more digital books associated with either a particular bookmark file or that is received as a gift. For example, in contrast to graphical representation of digital book 415, digital book 420 is displayed to include graphical element 425. Graphical element 425 may indicate that title 420 was received as a gift, includes a digital engraving, and/or includes a novelty bookmark. Selection of graphical element 420 may result in presentation of bookmark data.

In certain embodiments, multiple bookmark files may be stored by device 400, wherein bookmark files may be selectively applied to graphical display elements 410. It should further be appreciated that user interface 400 may allow for display 405 to be adjusted as depicted by directions 430 and 435. In that fashion, the display may be updated to display other titles.

Referring now to FIG. 5, a graphical representation is depicted of a message, and in particular a greeting card, that may be provided by a reader application. In certain embodiments, the bookmark file may be configured to store text and/or image data to allow a donor of a digital book to associate a greeting message with a digital book. FIG. 5 depicts display 505 of device 500 providing a display for a greeting card including text 510 and image data 515. In certain embodiments, the greeting card or message may be generated via an identification of a network site. The user may select displayed button 520 to exit the message and initiate display of the digital book by the reader application. Display of the greeting card is depicted as overlaying a display of the reader application.

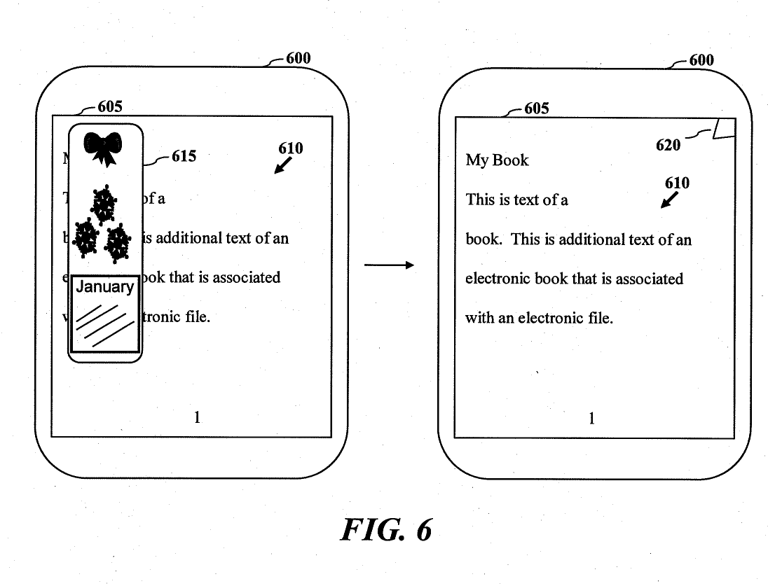

Referring now to FIG. 6, a graphical representation is depicted of data associated with a bookmark file according to another embodiment. Device 600 may be configured to display a user interface of a reader application on display 605. The user interface may include display of text of a digital book, shown as 610, and a graphical representation of digital bookmark 615. As depicted, device 500 displays a single page view of the digital book in a portrait orientation. Display of digital bookmark 615 may alternatively relate to one or more of a ribbon, string, etc.

According to one embodiment, bookmark 615 may be temporarily displayed following a user input command to initiate display of a digital book. As depicted in FIG. 6, device 600 may adjust display 605 to remove the display of bookmark 615 and display a dog ear, shown as 630, to identify a position or page. In one embodiment, device 600 may be configured to display dog ear 630 for a page identified by a user. In certain embodiments, the reader application may store the location for a bookmark file at the last page the reader viewed.

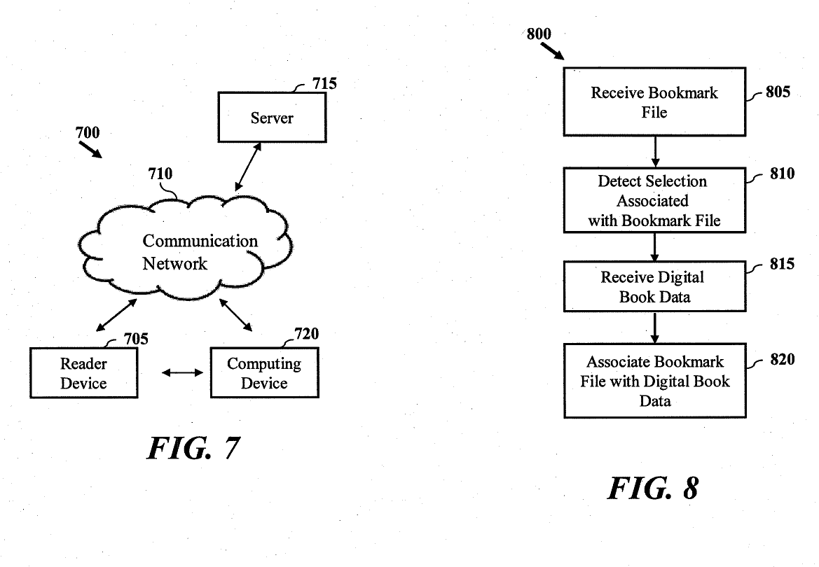

According to another embodiment, bookmark files and bookmark data may be transmitted relative to one or more devices. Communication of bookmark files and data may be transmitted and received via a communication network. FIG. 7 depicts a simplified system diagram of a system which may be employed for creating and transferring bookmark files and data for reader applications. In one embodiment, bookmark files may be created via a network connection. By way of example, a user may employ one of reader device 705 and computing device 720 (e.g., a personal computer) to access server 715 via communication network 710. Server 715 may relate to a host or backend server for a network site configured to allow for bookmark files to be created. Server 715 may provide an interface, such as a network page to view digital books that may be purchased. In certain embodiments, a user may connect reader device 705 to receive and/or transfer bookmark files and associated data with computing device 720. Bookmark file data on reader device 705 may be managed via one or more of server 715 and computing device 720.

Based on data provided by server 715, user can select free bookmark templates, or purchase premium bookmark templates from an online store. Based on the templates, users can create original greeting cards or messages and add one of text, a photo, a video or audio recording to be added to the bookmark file. The format of the bookmark file may allow for users to email the file and/or copy between devices independent from digital reading content.

Referring now to FIG. 8, a process for operation of a reader application is depicted according to another embodiment. Process 800 may be employed by a device (e.g., device 100) to present data associated with a bookmark file. Process 800 may be initiated by receiving a bookmark file at block 805. The bookmark file may be received by a device in an electronic communication, such as an email. Alternatively, the bookmark file may be received based on connection to a server (e.g., server 715) or computing device (e.g., computer 720). When a bookmark file is received, a user interface of a device may include a graphical representation identifying the bookmark file. Receipt of the bookmark file may include one or more or data for download and purchase of a digital book. At block 810, the device may detect a selection of the user interface associated with the bookmark file. Based on a selection of the bookmark file, the device may initiate a request for data of a digital book identified by the bookmark file at block 815. For example, the device may initiate a request to a server or network address for download of a digital book based on data provided by the bookmark file. Data for the digital book may be stored based on user selection of a graphical representation of the bookmark file. At block 820, the device may associate the bookmark file with a data for the digital book. In that fashion, a bookmark file including message data, such as a greeting card or digital engraving, can be associated with a particular digital book.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for presenting a reader application, the method comprising the acts of:
displaying, by a device, a user interface for a reader application, the user interface including a graphical representation identifying a digital book;
detecting a selection, by the device, of the user interface associated with the graphical representation identifying the digital book;
detecting a bookmark file associated with the digital book, the bookmark file stored by the device; and
presenting data associated with the bookmark file by the device, wherein the data is presented in association with presentation of the digital book.

2. The method of claim 1, wherein the reader application relates to an executable application configured for presentation of text for one or more digital books on a display of the device.

3. The method of claim 1, wherein the graphical representation identifying the digital book relates to one of a title, listing, and image identifying the digital book.

4. The method of claim 1, wherein the graphical representation identifying the digital book includes a graphical element to identify the digital book as a gift.

5. The method of claim 1, wherein the bookmark file is configured to store one or more of audio data, video data, image data and an identification of at least one digital book.

6. The method of claim 1, wherein the bookmark file is configured to provide data associated with one or more of a digital gift card and data for purchase of a digital book.

7. The method of claim 1, wherein the bookmark file is configured to store data to link the bookmark file with at least one digital book.

8. The method of claim 1, wherein presenting data associated with the bookmark file relates to presenting a greeting message as an overlay to the digital book.

9. The method of claim 1, wherein presenting data of the bookmark file relates to presenting a digital engraving associated with the digital book.

10. The method of claim 1, further comprising receiving the bookmark file, by the device, in an electronic communication, wherein the bookmark file includes one or more of data for download and purchase of a digital book.

11. The method of claim 10, further comprising storing data for the digital book based on user selection of a graphical representation of the bookmark file.

12. A computer program product stored on computer readable medium including computer executable code for presenting a reader application, the computer program product comprising:
computer readable code to display a user interface for a reader application, the user interface including a graphical representation identifying a digital book;
computer readable code to detect a selection of the user interface associated with the graphical representation identifying the digital book;
computer readable code to detect a bookmark file associated with the digital book, the bookmark file stored by the device; and
computer readable code to present data associated with the bookmark file by a device, wherein the data is presented in association with presentation of the digital book.

13. The computer program product of claim 12, wherein the reader application relates to an executable application configured for presentation of text for one or more digital books on a display of the device.

14. The computer program product of claim 12, wherein the graphical representation identifying the digital book relates to one of a title, listing, and image identifying the digital book.

15. The computer program product of claim 12, wherein the graphical representation identifying the digital book includes a graphical element to identify the digital book as a gift.

16. The computer program product of claim 12, wherein the bookmark file is configured to store one or more of audio data, video data, image data and an identification of at least one digital book.

17. The computer program product of claim 12, wherein the bookmark file is configured to provide data associated with one or more of a digital gift card and data for purchase of a digital book.

18. The computer program product of claim 12, wherein the bookmark file is configured to store data to link the bookmark file with at least one digital book.

19. The computer program product of claim 12, wherein presenting data associated with the bookmark file relates to presenting a greeting message as an overlay to the digital book.

20. The computer program product of claim 12, wherein presenting data of the bookmark file relates to presenting a digital engraving associated with the digital book.

21. The computer program product of claim 12, further comprising computer readable code to receive the bookmark file in an electronic communication, wherein the bookmark file includes one or more of data for download and purchase of a digital book.

22. The computer program product of claim 21, further comprising storing data for the digital book based on user selection of a graphical representation of the bookmark file.

23. A device comprising:
a display; and
a processor coupled to the display, the processor configured to
display a user interface for a reader application, the user interface including a graphical representation identifying a digital book;
detect a selection of the user interface associated with the graphical representation identifying the digital book;
detect a bookmark file associated with the digital book, the bookmark file stored by the device; and
control presentation of data associated with the bookmark file, wherein the data is presented in association with presentation of the digital book.

24. The device of claim 23, wherein the device relates to one or more of an eReader, personal communication device, handheld computing device, and computing device in general.
